(19) United States
(12) Patent Application Publication
(10) Pub. No.: US 2026/0367685 A1
(43) Pub. Date: Nov. 19, 2026

(54) ELECTRONIC APPARATUS, NON-TRANSITORY COMPUTER-READABLE RECORDING MEDIUM, AND POWER CONSUMPTION CALCULATING METHOD

(71) Applicant: KYOCERA DOCUMENT SOLUTIONS INC., OSAKA-SHI (JP)

(72) Inventors: MASAHIRO SUZUKI, OSAKA-SHI, OSAKA (JP); NAOKI TAKEUCHI, OSAKA-SHI, OSAKA (JP); RYOTA YAGANE, OSAKA-SHI, OSAKA (JP); MANORI DISSANAYAKE, OSAKA-SHI, OSAKA (JP)

(21) Appl. No.: 19/536,243

(22) Filed: Feb. 11, 2026

(30) Foreign Application Priority Data
Feb. 17, 2025 (JP) 2025-023711

(51) Int. Cl. G06F 1/28; H04N 1/00

(52) U.S. Cl. CPC G06F 1/28; H04N 1/00888

(57) ABSTRACT

An electronic apparatus includes a first calculator, a second calculator, and a power consumption calculator. The first calculator calculates first power consumption using regression analysis upon execution of a specific mode that enables a job to be executed in different types of settings. The second calculator calculates second power consumption using status addition upon execution of every mode except for the specific mode. The power consumption calculator calculates a total of the first power consumption and the second power consumption as power consumption.

### CROSS-REFERENCE TO RELATED PATENT APPLICATION

This application claims the benefit of Japanese Priority Patent Application JP 2025-023711 filed Feb. 17, 2025, the entire contents of which are incorporated herein by reference.

### FIELD OF THE DISCLOSURE

The present disclosure relates to an electronic apparatus, a non-transitory computer-readable recording medium that has recorded therein a power consumption calculating program used to calculate power consumption of the electronic apparatus, and a method for calculating the power consumption.

### BACKGROUND OF THE DISCLOSURE

Typically, power consumption is calculated on the basis of a power consumption reference for each operation mode of an image forming apparatus (a multifunction peripheral) and on the basis of data of an operation time in the operation mode.

### SUMMARY OF THE DISCLOSURE

An electronic apparatus according to an embodiment of the present disclosure includes a first calculator, a second calculator, and a power consumption calculator. The first calculator calculates first power consumption using regression analysis upon execution of a specific mode that enables a job to be executed in different types of settings. The second calculator calculates second power consumption using status addition upon execution of every mode except for the specific mode. The power consumption calculator calculates a total of the first power consumption and the second power consumption as power consumption.

A power consumption calculating program according to an embodiment of the present disclosure that has been recorded in a non-transitory computer-readable recording medium causes a control circuit of an electronic apparatus to operate as a first calculator, a second calculator, and a power consumption calculator. The first calculator calculates first power consumption using regression analysis upon execution of a specific mode that enables a job to be executed in different types of settings. The second calculator calculates second power consumption using status addition upon execution of every mode except for the specific mode. The power consumption calculator calculates a total of the first power consumption and the second power consumption as power consumption.

A power consumption calculating method according to an embodiment of the present disclosure is performed by a power consumption calculating program being executed by a control circuit of an electronic apparatus. The power consumption calculating method includes calculating first power consumption using regression analysis upon execution of a specific mode that enables a job to be executed in different types of settings. Second power consumption is calculated using status addition upon execution of every mode except for the specific mode. A total of the first power consumption and the second power consumption is calculated as power consumption.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 illustrates a hardware configuration of an image forming apparatus according to an embodiment of the present disclosure.

FIG. 2 illustrates a functional configuration of the image forming apparatus.

FIG. 3 illustrates a flowchart of an operation of the image forming apparatus.

FIG. 4 illustrates duration of each mode and a power consumption reference for the mode in a specific example.

### DETAILED DESCRIPTION OF THE EXEMPLARY EMBODIMENTS

The typical method for calculating power consumption is a simple approach. Thus, it is easy to perform the method, and it is also easy to explain to a user about the calculation method. However, power consumption in the copy/print mode is also calculated in the copy/print mode using a certain power consumption reference. Thus, power consumption is not calculated depending on a printing condition such as a difference between color printing and monochrome printing, a printing rate, or double-sided printing. This results in a reduction in a degree of accuracy in calculated power consumption.

In view of the circumstances described above, the present disclosure makes it possible to calculate power consumption more precisely.

Hereinafter, embodiments of the present disclosure will be described with reference to the drawings. In the present embodiment, an image forming apparatus such as a multifunction peripheral is described as an electronic apparatus. However, another type of electronic apparatus may be acceptable.

### 1. Hardware Configuration of Image Forming Apparatus

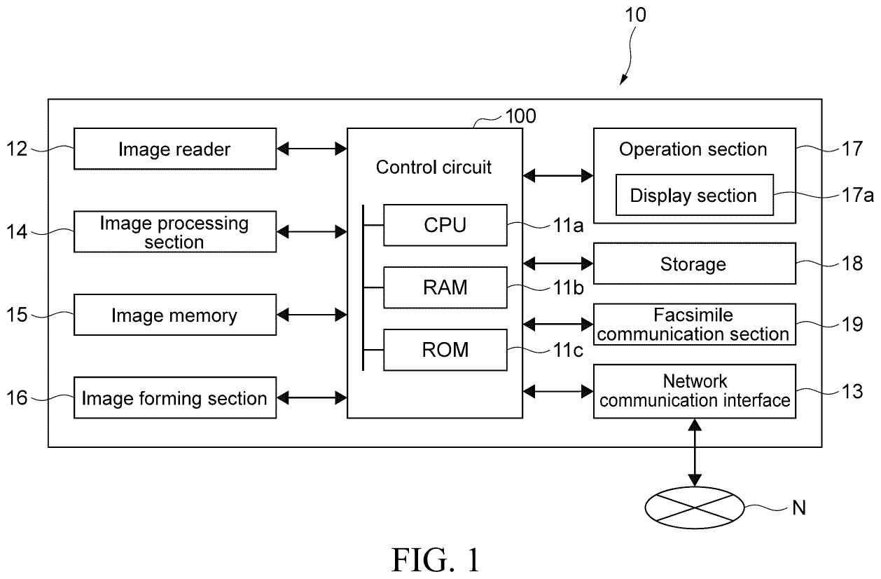

FIG. 1 illustrates a hardware configuration of an image forming apparatus according to an embodiment of the present disclosure.

The image forming apparatus 10 includes a control circuit 100 that is included in a computer. The control circuit 100 includes, for example, a central processing unit (CPU) 11a that is a processor, a random access memory (RAM) 11b, a read only memory (ROM) 11c that is a memory, and a dedicated hardware circuit, and controls an overall operation of the image forming apparatus 10. The CPU 11a loads an information processing program stored in the ROM 11c into the RAM 11b and executes the program. The ROM 11c permanently stores therein, for example, a program executed by the CPU 11a and data. The ROM 11c is an example of a non-transitory computer-readable recording medium.

The control circuit 100 is connected to, for example, an image reader 12 (an image scanner), an image processing section 14 (including a graphics processing unit (GPU)), an image memory 15, an image forming section 16 (a printer), a touchscreen (a front panel) 17 that is an operation section including a display section 17a, a large-capacity nonvolatile storage apparatus 18 such as a hard disk drive (HDD) or a solid state drive (SSD), a facsimile communication section 19, and a network communication interface 13 (a communication section). The control circuit 100 controls operations of the connected components described above, and performs transmission of a signal or data to and reception of a signal or data from each of the connected components. The operation section corresponding to the touchscreen 17 is an embodiment of an input apparatus, and a sound input apparatus that includes a microphone may be provided as the input apparatus.

### 2. Functional Configuration of Image Forming Apparatus

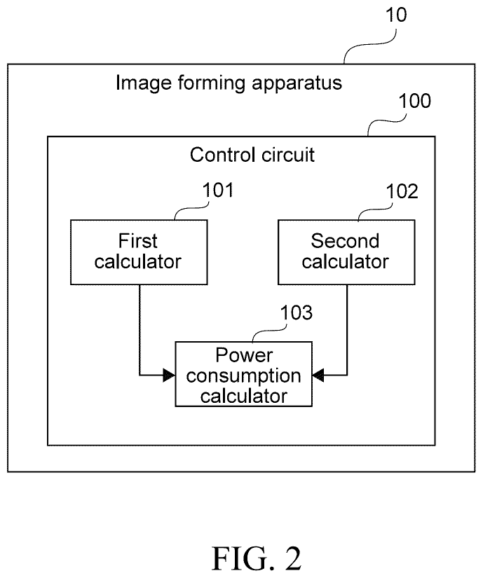

FIG. 2 illustrates a functional configuration of the image forming apparatus.

In the control circuit 100 of the image forming apparatus 10, the CPU 11a loads a power-saving program stored in the ROM 11c into the RAM 11b and executes the program to operate as a first calculator 101, a second calculator 102, and a power consumption calculator 103.

### 3. Flowchart of Operation of Image Forming Apparatus

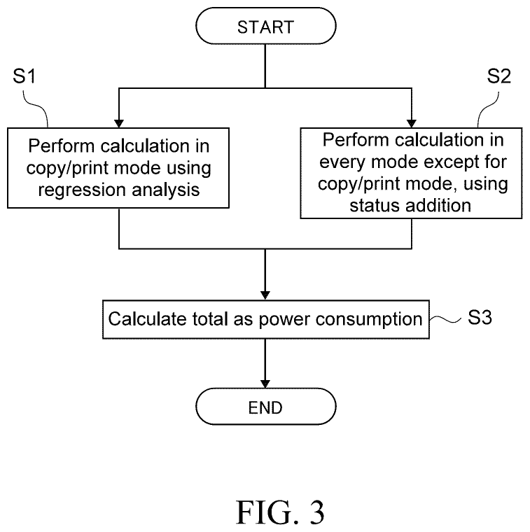

FIG. 3 illustrates a flowchart of an operation of the image forming apparatus.

The first calculator 101 calculates (Step S1) first power consumption using regression analysis upon execution of a specific mode (a copy/print mode) that enables a job to be executed in different types of settings.

Upon execution of every mode except for the specific mode (the copy/print mode), that is, an off mode, a sleep mode, a low-power mode, and a ready mode, the second calculator 102 calculates (Step S2) second power consumption using status addition. The status addition is an approach of calculating, as power consumption, a total of values each obtained by multiplying duration of a corresponding one of the modes by power consumption in the mode. The low-power mode is a mode in which display on the front panel 17 is off. The ready mode corresponds to a normal state in which a job can be accepted.

The power consumption calculator 103 calculates (Step S3) a total of the first power consumption and the second power consumption as power consumption.

### 4. Regression Analysis

The regression analysis uses the following multiple regression formula to obtain an estimated value of power consumption caused when an electronic apparatus executes a job:

y=a₁x₁+a₂x₂+ . . . +aₙxₙ+b.

Here, y represents power consumption serving as a target variable. xₙ represents an explanatory variable, and there exists a plurality of the explanatory variables depending on the type of a setting for a job. aₙ represents a coefficient of partial regression. b, which is a constant term, represents total electric power essentially necessary to execute the job.

The multiple regression formula is a multiple regression formula used to obtain an estimated value of power consumption caused when the image forming apparatus 10 executes a single job, and is a power consumption estimating model. n is an integer that is greater than or equal to two.

For example, something that corresponds to the number of sheets of paper printed that represents the number of recording media on which an image is printed on a target job, may be adopted as xₙ. For example, when one document is placed on contact glass to be copied, the number of copies to be set may be treated as the number of sheets of paper printed on a copying job. Further, when a plurality of documents is placed in an automatic document feeder (ADF) to be copied and when the image forming apparatus includes a preview printing function to perform various settings through a preview display screen to copy all of the plurality of documents read in advance, the product of the number of documents read and the number of copies to be set may be treated as the number of sheets of paper printed.

For example, something that corresponds to a recording-medium size that represents a size of a recording medium on which an image is printed on a target job, may be adopted as xₙ. For example, a value of an explanatory variable corresponding to the recording-medium size may be determined according to the recording-medium size, such as five for A4 size and two for A5 size. The value of the explanatory variable corresponding to the recording-medium size may be, for example, a numerical value proportional to the area corresponding to the recording-medium size.

For example, something that corresponds to a recording-medium type that represents the type of recording medium on which an image is printed on a target job, may be adopted as xₙ. For example, a value of an explanatory variable corresponding to the recording-medium type may be determined according to the recording-medium type, such as three for thick paper, two for plain paper, and one for thin paper. The value of the explanatory variable corresponding to the recording-medium type may be, for example, a numerical value proportional to a thickness corresponding to the recording-medium type. The explanatory variable corresponding to the recording-medium type may be provided for each recording-medium type. In the case in which the explanatory variable corresponding to the recording-medium type is provided for each recording-medium type, for example, the value of the explanatory variable for each recording-medium type may be one when a target recording-medium type is specified in a setting for a job, and may be zero when the target recording-medium type is not specified in the setting for the job. For example, in the case in which the explanatory variable corresponding to the recording-medium type is provided for each recording-medium type, a value of the explanatory variable for thick paper may be one when the thick paper is specified as the recording-medium type in a setting for a job, and may be zero when the thick paper is not specified as the recording-medium type in the setting for the job.

For example, something that corresponds to double-sided/single-sided, which represents which of double-sided printing and single-sided printing is to be performed on a target job, may be adopted as xₙ. For example, the value of the explanatory variable corresponding to double-sided/single-sided may be one when double-sided is specified in a setting for a job, and may be zero when single-sided is specified in the setting for the job.

For example, something that corresponds to color/monochrome, which represents which of color printing and monochrome printing is to be performed on a target job, may be adopted as xₙ. For example, a value of an explanatory variable corresponding to color/monochrome may be one when color is specified in a setting for a job, and may be zero when monochrome is specified in the setting for the job. Different explanatory variables corresponding to color/monochrome may be provided for color printing and monochrome printing. In the case in which different explanatory variables corresponding to color/monochrome are provided for color printing and monochrome printing, for example, the value of the explanatory variable for color printing may be one when the color printing is specified in a setting for a job, and may be zero when the color printing is not specified in the setting for the job. Likewise, in the case in which different explanatory variables corresponding to color/monochrome are provided for color printing and monochrome printing, for example, the value of the explanatory variable for monochrome printing may be one when the monochrome printing is specified in a setting for a job, and may be zero when the monochrome printing is not specified in the setting for the job.

For example, something that corresponds to integration representing the number of pages to be printed on one side of a recording medium, may be adopted as xₙ. For example, a value of an explanatory variable corresponding to integration may be eight when “no integration,” which indicates that the number of pages to be printed on one side of a recording medium is one, is specified in a setting for a job, and may be four when “2in1,” which indicates that the number of pages to be printed on one side of the recording medium is two, is specified in the setting for the job. The value of the explanatory variable corresponding to integration may be two when “4in1,” which indicates that the number of pages to be printed on one side of the recording medium is four, is specified in the setting for the job, and may be one when “8in1,” which indicates that the number of pages to be printed on one side of the recording medium is eight, is specified in the setting for the job.

When power consumption caused when the image forming apparatus 10 executes a job differs depending on a position of a medium supply portion that is supplied with a recording medium on which an image is printed on a target job, such as the case in which the number of times that a motor used to transport a recording medium is driven differs depending on the position of the medium supply portion supplied with a recording medium, something that corresponds to the position of the medium supply portion supplied with a recording medium on which an image is printed on a target job, may be adopted as xₙ.

When power consumption caused when the image forming apparatus 10 executes a job differs depending on a position of a medium discharge portion into which a recording medium on which an image is printed on a target job is discharged, such as the case in which the number of times that a motor used to transport a recording medium is driven differs depending on the position of the medium discharge portion into which a recording medium is discharged, something that corresponds to the position of the medium discharge portion into which a recording medium on which an image is printed on a target job is discharged, may be adopted as xₙ.

When the image forming apparatus 10 includes a function to perform post-processes, such as sorting, stapling, punching, and folding, with respect to a recording medium on which an image is printed, something that corresponds to the type of post-process performed on a recording medium on which an image is printed on a target job, may be adopted as xₙ.

xₙ may exist, for example, depending on a state of the image forming apparatus 10 when a target job is executed. For example, something that corresponds to an operation mode of the image forming apparatus 10 that corresponds to the state of the image forming apparatus 10 when a target job is executed, may be adopted as xₙ. Examples of the operation mode of the image forming apparatus 10 include a normal mode and a quiet mode that provides a quieter state than the normal mode. In the quiet mode, a motor used to rotate a polygon mirror in the printer 13 is stopped for a quiet state every time execution of a job is terminated. Thus, there is a need to drive, every time a job starts to be executed, the motor used to rotate the polygon mirror in the printer 13. Thus, more power consumption is caused in the quiet mode than in the normal mode.

b, which is a constant term, represents total electric power essentially necessary to execute a target job. For example, electric power used to increase, before printing, a temperature of a fixation roller included in the printer 13 up to a specific temperature and maintain the temperature of the fixation roller at the specific temperature, electric power used to stabilize, before printing, rotation of a motor used to rotate the fixation roller included in the printer 13, and electric power used to stabilize, before printing, rotation of a motor used to rotate a polygon mirror included in the printer 13 may be adopted as the electric power essentially necessary to execute a target job.

### 5. Specific Example

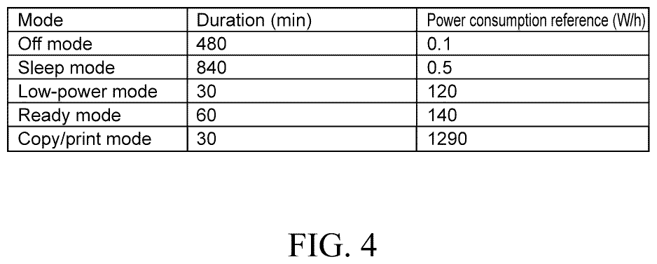

FIG. 4 illustrates duration of each mode and a power consumption reference for the mode in a specific example.

For example, when duration of each mode of the image forming apparatus 10 and a power consumption reference for the mode are as illustrated in FIG. 4 and when power consumption in the copy/print mode that is calculated using regression analysis is 400 W/h, power consumption (607.8 W/h) is calculated as indicated below.

power consumption (W/h)=duration (h) of off mode×power consumption (W/h) in off mode+duration (h) of sleep mode×power consumption (W/h) in sleep mode+duration (h) of low-power mode×power consumption (W/h) in low-power mode+duration (h) of ready mode×power consumption (W/h) in ready mode+power consumption (W/h) in copy/print mode that is calculated using regression analysis=(0.1×(480/60))+(0.5×(840/60))+(120×(30/60))+(140×(60/60))+400=607.8 W/h

### 6. Conclusion

In related art, power consumption is calculated on the basis of a power consumption reference for each operation mode of an image forming apparatus (a multifunction peripheral) and on the basis of data of an operation time in the operation mode. The status addition is a simple approach. Thus, it is easy to perform the method, and it is also easy to explain to a user about the calculation method. However, power consumption in the copy/print mode is also calculated in the copy/print mode using a certain power consumption reference. Thus, power consumption is not calculated depending on a printing condition such as a difference between color printing and monochrome printing, a printing rate, or double-sided printing. This results in a reduction in a degree of accuracy in calculated power consumption.

On the other hand, the regression analysis makes it possible to estimate power consumption of the image forming apparatus from a set value of the image forming apparatus and job execution information regarding the image forming apparatus. Thus, a drawback related to power consumption is overcome using the regression analysis. However, when power consumption is increased despite the fact that printing is not performed, such as the case in which power consumption is continuously caused due to occurrence of a jam or an error, or the case in which a sleep function is off, the regression analysis has the drawback of reducing a degree of accuracy in calculated power consumption.

Thus, in the present embodiment, first power consumption is calculated using regression analysis upon execution of a specific mode (the copy/print mode) that enables job to be executed in different types of settings. Further, upon execution of every mode except for the specific mode (the copy/print mode), that is, the off mode, the sleep mode, the low-power mode, and the ready mode, second power consumption is calculated using status addition. This makes it possible to provide a hybrid approach that mutually compensates for the drawback of the status addition and the drawback of the regression analysis, and thus to calculate power consumption more precisely and accurately.

Although each embodiment and each modified example of the present technology have been described above, the present technology is not limited to the above-mentioned embodiments, and various modifications can be made without departing from the gist of the present technology as a matter of course.

What is claimed is:

1. An electronic apparatus, comprising:
a first calculator that calculates first power consumption using regression analysis upon execution of a specific mode that enables a job to be executed in different types of settings;
a second calculator that calculates second power consumption using status addition upon execution of every mode except for the specific mode; and
a power consumption calculator that calculates a total of the first power consumption and the second power consumption as power consumption.

2. The electronic apparatus according to claim 1, wherein
the regression analysis uses the following multiple regression formula to obtain an estimated value of power consumption caused when the electronic apparatus executes the job:
y=a₁x₁+a₂x₂+ . . . +aₙxₙ+b, where
y represents power consumption serving as a target variable,
xₙ represents an explanatory variable, with there existing a plurality of the explanatory variables depending on the type of the setting for the job,
aₙ represents a coefficient of partial regression, and
b, which is a constant term, represents total electric power essentially necessary to execute the job.

3. The electronic apparatus according to claim 1, wherein
the status addition is an approach of calculating a total of values each obtained by multiplying duration of a corresponding one of the modes by power consumption in the mode.

4. The electronic apparatus according to claim 1, wherein
the specific mode is a copy/print mode.

5. A non-transitory computer-readable recording medium that has stored therein a power consumption calculating program that causes a control circuit of an electronic apparatus to operate as a first calculator, a second calculator, and a power consumption calculator,
the first calculator calculating first power consumption using regression analysis upon execution of a specific mode that enables a job to be executed in different types of settings,
the second calculator calculating second power consumption using status addition upon execution of every mode except for the specific mode,
the power consumption calculator calculating a total of the first power consumption and the second power consumption as power consumption.

6. A power consumption calculating method that is performed by a power consumption calculating program being executed by a control circuit of an electronic apparatus, the power consumption calculating method comprising:
calculating first power consumption using regression analysis upon execution of a specific mode that enables a job to be executed in different types of settings;
calculating second power consumption using status addition upon execution of every mode except for the specific mode; and
calculating a total of the first power consumption and the second power consumption as power consumption.
